(19) United States
(12) Patent Application Publication
(10) Pub. No.: US 2013/0061152 A1
(43) Pub. Date: Mar. 7, 2013

(54) THREE DIMENSIONAL GRAPHICAL USER INTERFACE

(71) Applicants: Sándor Dolgos, Szentendre (HU); Zsolt Kokas, Gyorszemere (HU)

(72) Inventors: Sándor Dolgos, Szentendre (HU); Zsolt Kokas, Gyorszemere (HU)

(73) Assignee: B. Braun Avitum AG, Melsungen (DE)

(21) Appl. No.: 13/223,635

(22) Filed: Sep. 1, 2011

(51) Int. Cl. G06F 3/00

(52) U.S. Cl. 715/753

(57) ABSTRACT

Graphical user interfaces (GUIs) are disclosed. One GUI includes a 3D object. The 3D object has a plurality of surfaces. The surfaces include one or more surfaces associated with a first user and one or more surfaces associated with a second user. The 3D object is rotatable in order to selectively display at least one of the surfaces. Rotation of the 3D object around a first axis changes the selectively displayed surface between the one or more surfaces associated with the first user and the one or more surfaces associated with the second user. Rotation of the 3D object around a second axis changes the selectively displayed surface between one of the one or more surfaces associated with the first user and another one of the one or more surfaces associated with the first user. The GUI may be implemented on the display screen of a medical device.

### FIELD OF THE INVENTION

The present invention relates generally to graphical user interfaces, and more particularly, to three-dimensional (3D) graphical user interfaces for electronic devices.

### BACKGROUND OF THE INVENTION

Electronic devices commonly utilize display screens to present information to a user. Display screens generally include a graphical user interface (GUI) to facilitate the presentation of that information, and to facilitate input from the user. A GUI may have a particular arrangement or orientation of data that makes the information more easily viewed and understood by the user.

Recently, electronic medical devices have incorporated display screens for presenting information to medical care personnel. For example, an electronic infusion pump may include a display screen having a GUI for presenting information on the pump's operation to a doctor or nurse. GUIs that facilitate user viewing and understanding are desired.

### SUMMARY OF THE INVENTION

Aspects of the present invention relate to graphical user interfaces.

In accordance with one aspect of the present invention, a graphical user interface is disclosed. The graphical user interface is for presenting information on a display screen of an electronic device. The graphical user interface includes a three-dimensional (3D) object. The 3D object has a plurality of surfaces. The plurality of surfaces include one or more surfaces associated with a first user and one or more surfaces associated with a second user. The 3D object is rotatable in order to selectively display at least one of the plurality of surfaces. Rotation of the 3D object around a first axis changes the selectively displayed at least one surface between the one or more surfaces associated with the first user and the one or more surfaces associated with the second user. Rotation of the 3D object around a second axis different from the first axis changes the selectively displayed at least one surface between one of the one or more surfaces associated with the first user and another one of the one or more surfaces associated with the first user.

In accordance with another aspect of the present invention, a medical device is disclosed. The medical device is for use in providing treatment to a patient. The medical device includes a functional component, a display screen, and a processor. The functional component is configured to provide the treatment to the patient. The processor is programmed to implement a graphical user interface on the display screen to present information related to the functional component.

In accordance with still another aspect of the present invention, a method for presenting information on a display screen of an electronic device is disclosed. The method includes the steps of presenting a three-dimensional (3D) object on the display screen, the 3D object having a plurality of surfaces, the plurality of surfaces including one or more surfaces associated with a first user and one or more surfaces associated with a second user; receiving input from a user, the input comprising an instruction to rotate the 3D object in order to selectively display at least one of the plurality of surfaces; and rotating the 3D object in response to receiving the input. Rotation of the 3D object around a first axis changes the selectively displayed at least one surface between the one or more surfaces associated with the first user and the one or more surfaces associated with the second user. Rotation of the 3D object around a second axis different from the first axis changes the selectively displayed at least one surface between one of the one or more surfaces associated with the first user and another one of the one or more surfaces associated with the first user.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram illustrating an exemplary electronic device in accordance with aspects of the present invention;

FIGS. 2A and 2B are diagrams illustrating an exemplary graphical user interface in accordance with aspects of the present invention;

FIGS. 3A, 3B, and 3C are images of exemplary surfaces of the graphical user interface of FIGS. 2A and 2B;

FIGS. 4A and 4B are diagrams illustrating exemplary rotations of the graphical user interface of FIGS. 2A and 2B;

FIG. 5 is a another diagram illustrating the graphical user interface in of FIGS. 2A and 2B; and

FIG. 6 is a flow chart illustrating an exemplary method for presenting information in accordance with aspects of the present invention.

### DETAILED DESCRIPTION OF THE INVENTION

The graphical user interfaces (GUIs) disclosed herein are usable in conjunction with electronic devices having multiple users. These embodiments may be particularly suitable for transitioning between different user-specific interfaces of a GUI. While the exemplary embodiments of the present invention are described herein in the context of medical devices, it will be understood by one of ordinary skill in the art that the invention is not so limited. The GUIs described herein are usable to present information on the display screen of any suitable electronic device.

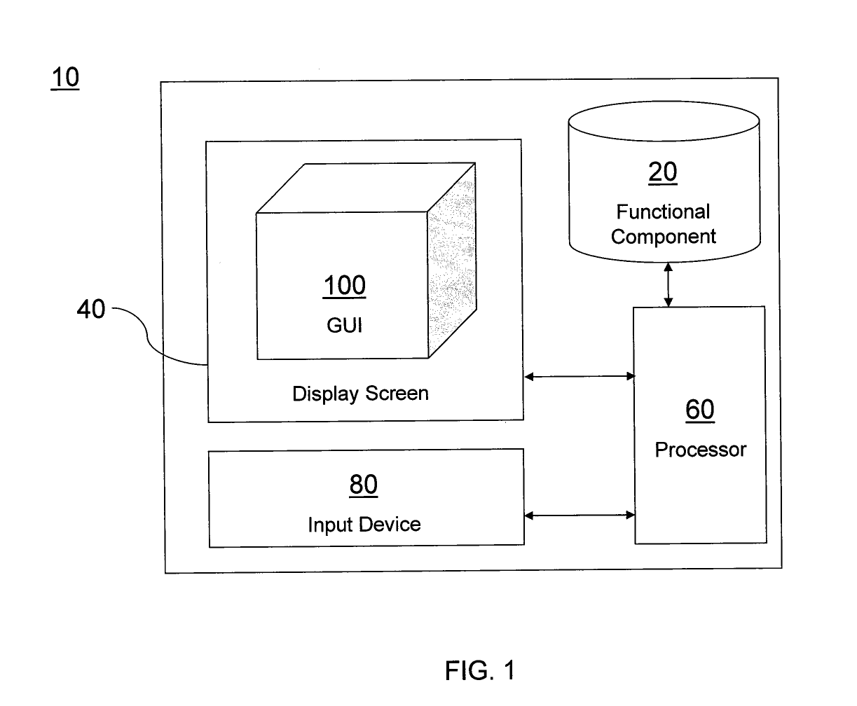

Referring now to the drawings, FIG. 1 illustrates an electronic device 10 in accordance with aspects of the present invention. Electronic device 10 may be an electronic medical device such as, for example, an infusion pump. As a general overview, electronic device 10 includes a functional component 20, a display screen 40, and a processor 60. Additional details of electronic device 10 are described herein.

Functional component 20 performs one or more functions of electronic device 10. Where electronic device 10 is a medical device, functional component 20 may provide a treatment to a patient. In one embodiment, functional component 20 is an infusion pumping apparatus including a fluid source, tubing, and a peristaltic pump, for example. Other suitable functional components 20 will be known to one of ordinary skill in the art from the description herein.

Display screen 40 presents information to a user of electronic device 10. In one embodiment, display screen 40 is a touch panel that enables input by the user as well as displaying information. Suitable touch panels for use as display screen 40 will be known to one of ordinary skill in the art from the description herein.

Processor 60 controls the operation of electronic device 10. Processor 60 operates functional component 20 to perform its corresponding function, e.g., providing treatment to a patient. Processor 60 further controls display screen 40 to display information on the operation of functional component 20. In particular, processor 60 is programmed to implement a graphical user interface (GUI) 100 on display screen 40 in order to present information related to functional component 20 to a user. Additional details of GUI 100 are set forth below.

It will be understood that electronic device 10 is not limited to the above components, but may include alternative components and additional components, as would be understood by one of ordinary skill in the art from the description herein. For example, processor 60 may include multiple processors, e.g., a first processor for controlling operation of functional component 20 and a second processor for displaying information on display screen 40.

Electronic device 10 may further include an input device 80. Input device 80 enables the receipt of information from the user of electronic device 10. Input device 80 further transmits the received information to processor 60 for use in operating electronic device 10. In one embodiment, as set forth above, display screen 40 may be a touch screen configured to function as input device 80. In an alternative embodiment, input device 80 may be a separate component configured to receive input from a user. For example, input device 80 may be a keypad, mouse, barcode scanner, radio-frequency (RF) receiver, or other input device. Suitable input devices 80 will be known to one of ordinary skill in the art from the description herein.

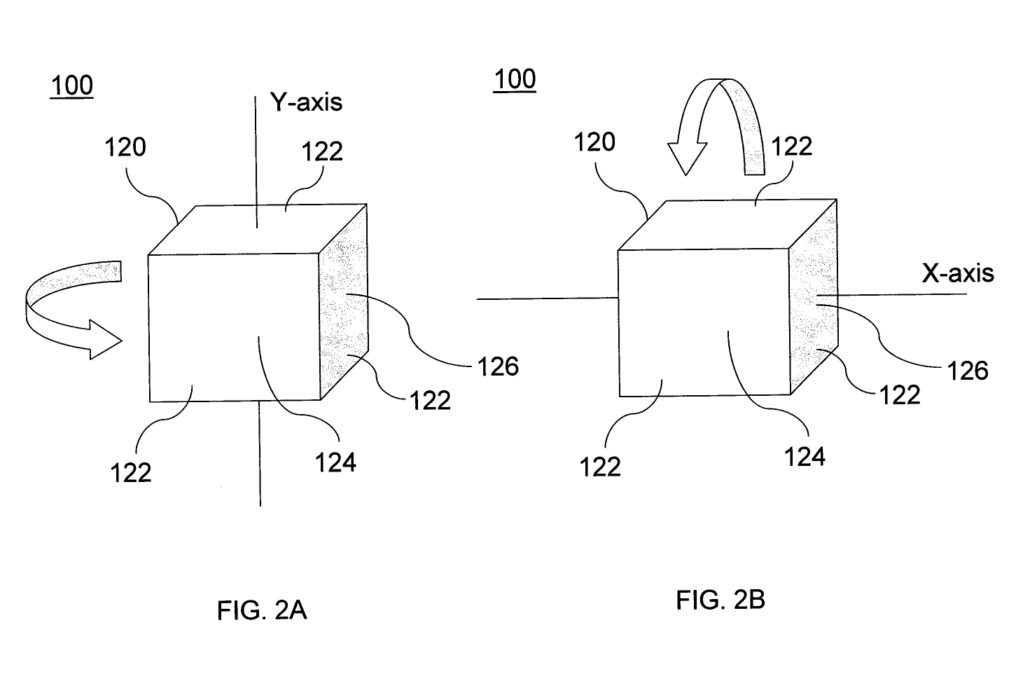

FIGS. 2A-5 illustrate a GUI 100 in accordance with aspects of the present invention. GUI 100 is usable to present information on the display screen 40 of electronic device 10. GUI 100 may be particularly suitable for use with electronic devices 10 having multiple users. As a general overview, GUI 100 includes a three-dimensional (3D) object 120. Additional details of GUI 100 are described below.

3D object 120 is a three-dimensional representation of a geometric solid on a two-dimensional display. In an exemplary embodiment, 3D object 120 is a polyhedron such as, for example, a cube. However, it will be understood to one of ordinary skill in the art that the shape of 3D object 120 is not limited. The shape of 3D object 120 may be selected based on a desired number of surfaces of 3D object 120, as will be explained below.

3D object 120 has a plurality of surfaces 122 on which information is arranged and displayed to the user. When GUI 100 is for use on an electronic device 10 with multiple users, the information for respective users may be assigned to different surfaces 122 of 3D object 120. In an exemplary embodiment, the plurality of surfaces 122 on 3D object 120 include one or more surfaces 124 associated with a first user and one or more surfaces 126 associated with a second user.

GUI 100 selectively displays at least one of the plurality of surfaces 122 at a time on display screen 40. The first user may view information associated with him or her when surfaces 124 are selectively displayed, and the second user may view information associated with him or her when surfaces 126 are selectively displayed. In order to change the surface(s) 122 that are selectively displayed by GUI 100, 3D object 120 may be rotated, as set forth below.

3D object 120 is rotatable in a plurality of different directions. In an exemplary embodiment, 3D object 120 may be rotated either horizontally (i.e., around the Y-axis) or vertically (i.e., around the X-axis), as shown with arrows in FIGS. 2A and 2B.

In accordance with aspects of the present invention, the surfaces 122 of 3D object 120 may be arranged such that the direction in which 3D object 120 is rotated causes a predetermined change in the information displayed by GUI 100. For example, rotation of 3D object 120 around a first axis (e.g., the Y-axis) changes the surface being displayed between one of the surfaces 124 associated with the first user and one of the surfaces 126 associated with the second user. Rotation of 3D object 120 around a second axis (e.g., the X-axis) changes the surface being displayed between separate surfaces 124 associated with the first user. The above feature desirably enables users of electronic device 10 to more easily understand and transition between user-specific information.

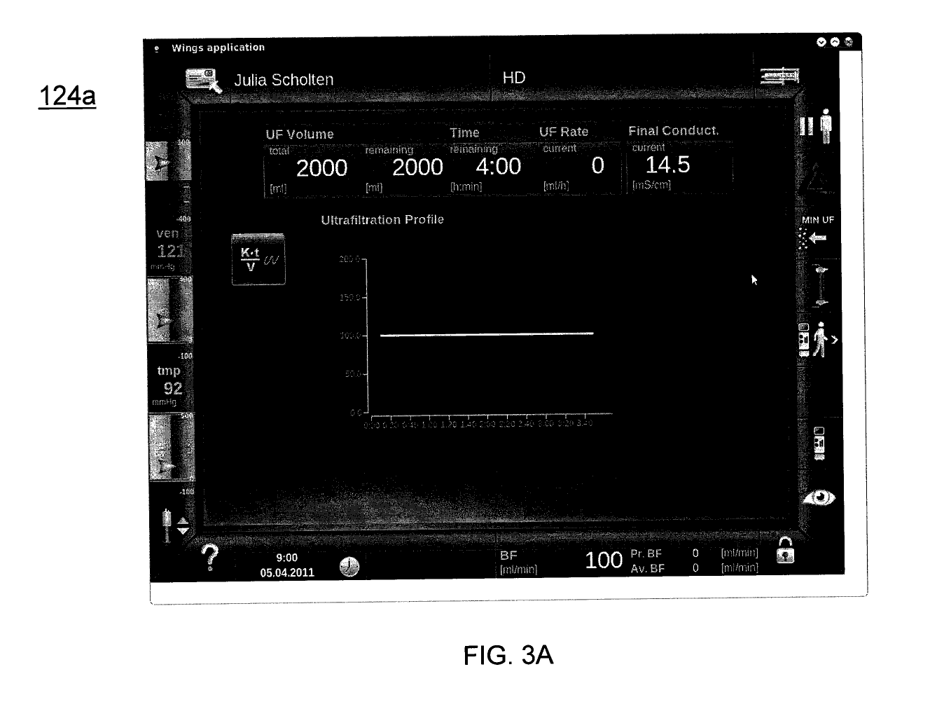

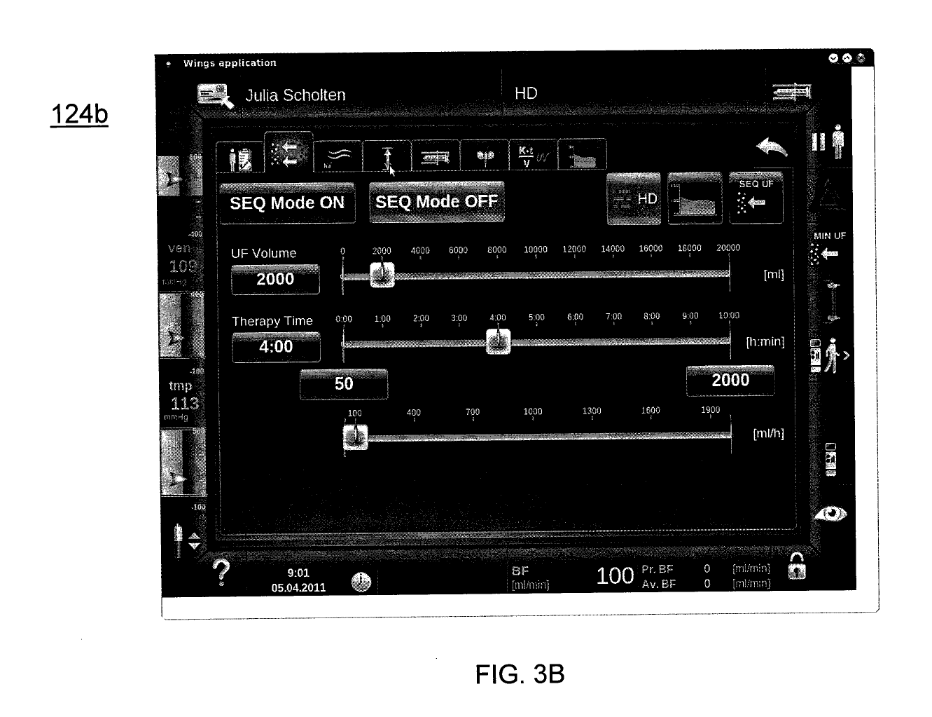

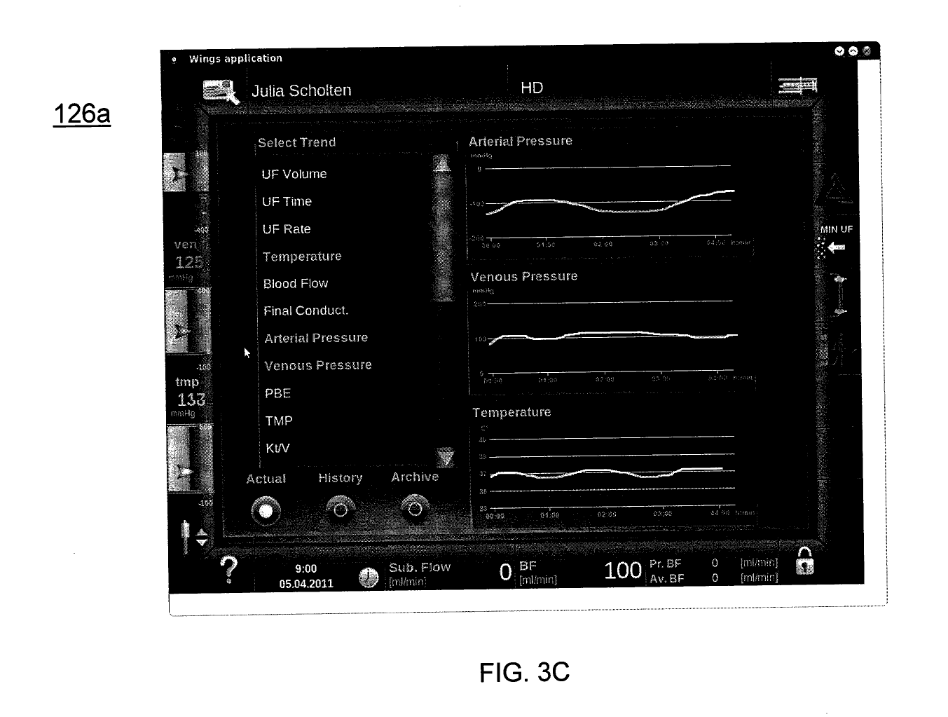

For the purposes of illustrating the operation of GUI 100, an exemplary rotation of 3D object 120 will now be described with respect to FIGS. 2A-4B. In one embodiment, GUI 100 is implemented on the display screen of an infusion pump. The infusion pump is adapted for operation by a number of users, including for example a nurse, a doctor, a technician, and a patient. 3D object 120 includes a plurality of surfaces 124 including information associated with the nurse. For example, the 3D object 120 includes one surface 124a including treatment history information (an image of which is shown in FIG. 3A), and another surface 124b including infusion pump programming information (an image of which shown in FIG. 3B). The 3D object 120 also includes a surface 126a including information associated with the doctor (an image of which shown in FIG. 3C).

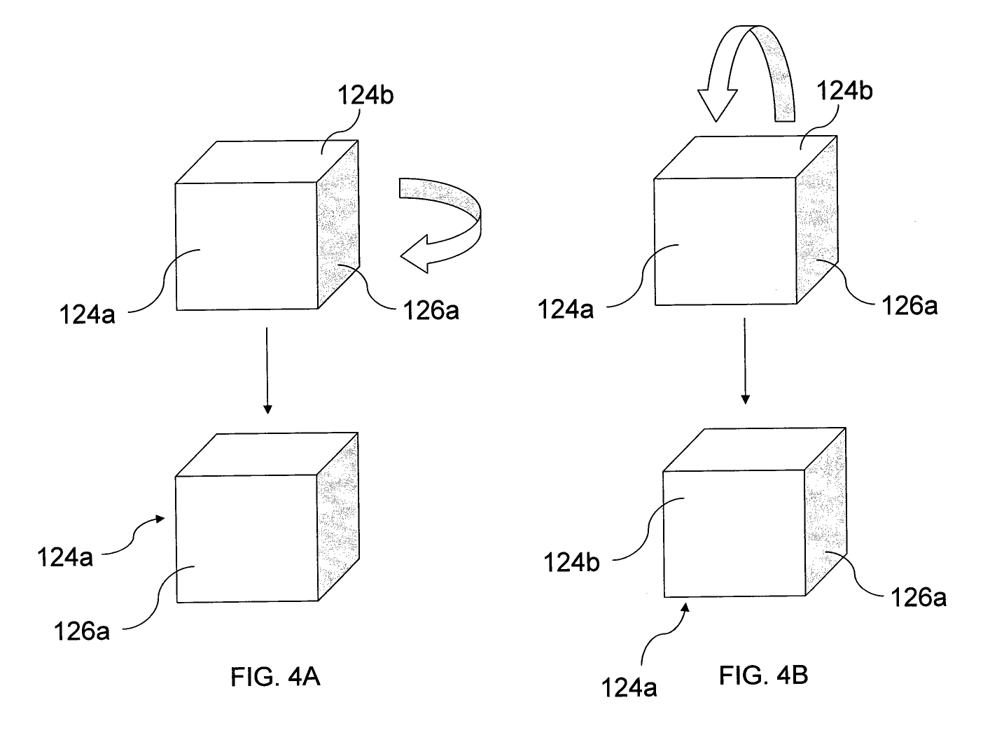

Surfaces 124a and 126a are arranged side-by-side horizontally on 3D object 120. Surfaces 124a and 124b are arranged side-by-side vertically on 3D object 120. Accordingly, rotation of 3D object 120 around the Y-axis changes the surface being displayed from a nurse-specific surface 124a to a doctor-specific surface 126a, as shown in FIG. 4A. Rotation of 3D object 120 around the X-axis changes the surface being displayed from a nurse treatment history information surface 124a to the nurse pump programming surface 124b, as shown in FIG. 4B.

While 3D object 120 is illustrated as having a nurse-specific surface 124b on its top surface, it will be understood by one of ordinary skill in the art that the invention is not so limited. Because 3D object 120 is a virtual object implemented within GUI 100, the top surface of 3D object 120 may be changed based on the currently displayed user interface. For example, when a nurse-specific surface 124a is displayed, then rotating 3D object 120 around the X-axis may cause GUI 100 to display another nurse-specific surface 124b. However, when a doctor specific surface 126a is displayed, rotating 3D object 120 around the X-axis may cause GUI 100 to display another doctor-specific surface (not shown). In this way, rotation about the X-axis may operate to change the user-specific information being displayed (e.g. treatment history, pump programming, etc.) by GUI 100, while rotation around the Y-axis operates to change the actual user interface being displayed (e.g. nurse, doctor, technician, etc.) by GUI 100.

In the above exemplary embodiment, it may be desirable that certain users of the infusion pump (e.g., a technician) are unable to access the surfaces associated with certain other users (e.g., a doctor or nurse). Accordingly, GUI 100 may require authorization information by a user prior to enabling the rotation of 3D object 120 around the Y-axis from a technician-specific surface to a doctor-specific surface. In an exemplary embodiment, electronic device 10 may require a user to input the authorization information via input device 80 for verification by processor 60. The authorization information may be, for example, an ID number, password, barcode information, or any other suitable authorization information.

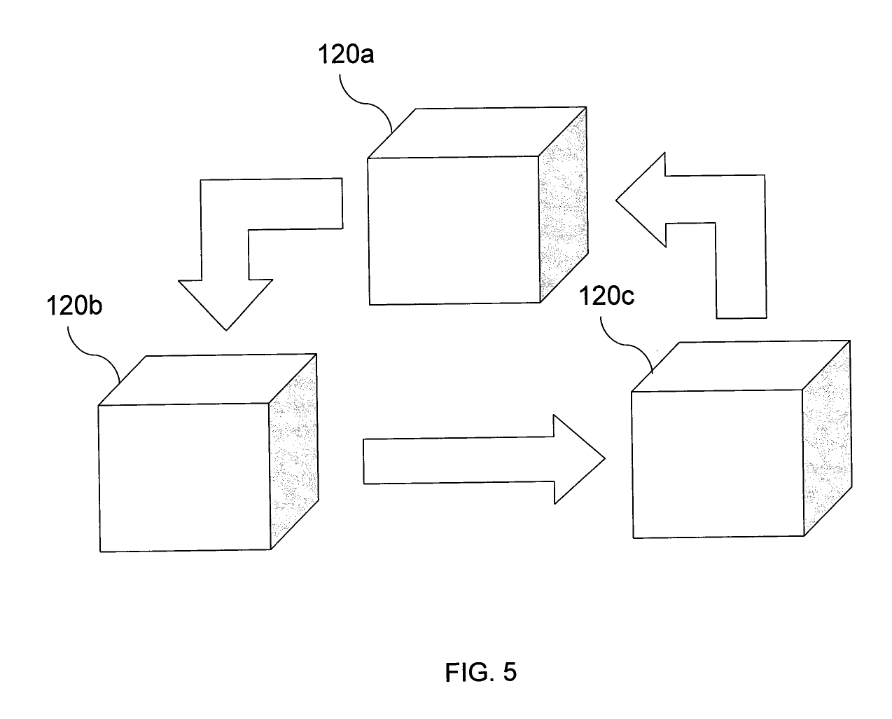

While GUI 100 has been described herein with only a single 3D object 120, it will be understood by one of ordinary skill in the art that the invention is not so limited. As illustrated in FIG. 5, GUI 100 may include a plurality of 3D objects 120a, 120b, 120c. 3D objects 120a, 120b, 120c may be repositionable in order to selectively display at least one surface 122 of one of the 3D objects 120a, 120b, 120c. It may be desirable to display the surface(s) 122 from only a single one of the plurality of 3D objects 120a, 120b, 120c at a time in order to facilitate easier visual recognition and understanding by the user.

In embodiments in which GUI 100 includes multiple 3D objects 120a, 120b, 120c, the information for respective modes of operation of the infusion pump may be assigned to different 3D objects 120a, 120b, 120c. In an exemplary embodiment, GUI 100 includes a 3D object 120a associated with an active therapy mode, a 3D object 120b associated with a therapy selection mode, and a 3D object 120c associated with a disinfection mode. In this way, repositioning of the 3D objects 120a, 120b, 120c may operate to change the operational mode of electronic device 10. Each 3D object 120 may then be individually rotated in the manner described above.

In the above exemplary embodiment, it may be desirable that certain users of the infusion pump (e.g., a patient) are unable to change the operational mode of the infusion pump. Accordingly, GUI 100 may require authorization information by a user prior to enabling the repositioning of 3D objects 120a, 120b, 120c. In an exemplary embodiment, electronic device 10 may require a user to input the authorization information as described above with respect to the rotation of 3D objects.

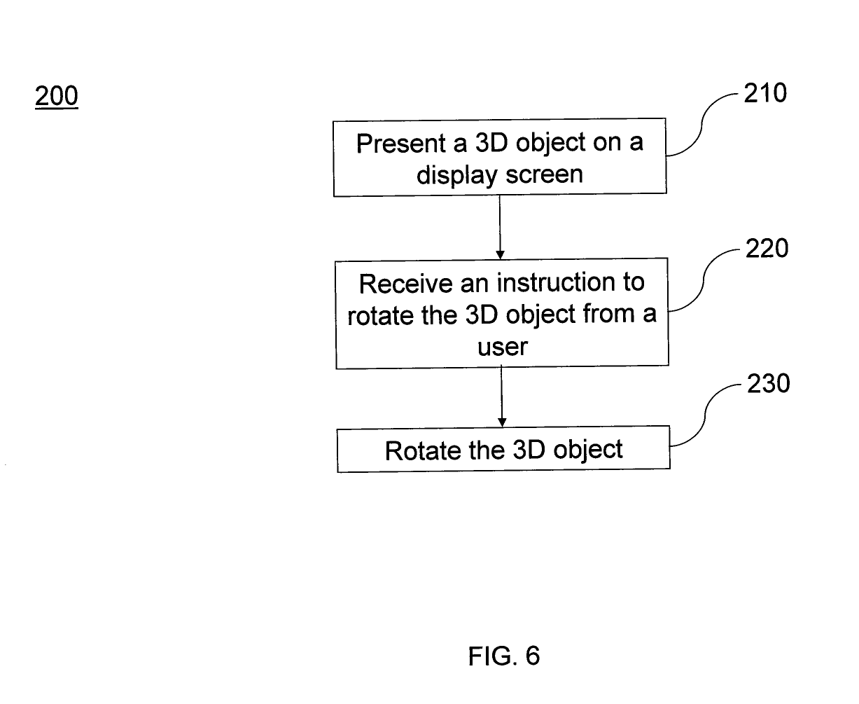

FIG. 6 shows an exemplary method 200 for presenting information on a display screen of an electronic device in accordance with aspects of the present invention. Method 200 may desirably be implemented by an electronic medical device such as, for example, an infusion pump. As a general overview, method 200 includes presenting a 3D object, receiving input from a user, and rotating the 3D object. Additional details of method 200 are described herein with respect to the components of electronic device 10 and GUI 100.

In step 210, a 3D object is presented on a display screen. In an exemplary embodiment, 3D object 120 is displayed on display screen 40 of electronic device 10. 3D object 120 has a plurality of surfaces 122 on which information is arranged and displayed to the user. When method 200 is implemented by an electronic device 10 having multiple users, the information for respective users may be assigned to different surfaces 122 of 3D object 120. For example, the plurality of surfaces 122 on 3D object 120 may include one or more surfaces 124 associated with a first user and one or more surfaces 126 associated with a second user.

In step 220, input is received from a user. The input comprises an instruction to rotate the 3D object in order to selectively display at least one of the plurality of surfaces. In an exemplary embodiment, a user of electronic device 10 inputs a rotation instruction using input device 80. Where display screen 40 operates as a touch panel, the user may provide the input by touching the touch panel and moving his or her finger in the direction of desired rotation. Alternatively, a user may enter a rotation instruction using a keypad or mouse as input device 80. Suitable components for receiving rotation instructions from a user will be understood to one of ordinary skill in the art from the description herein.

In step 230, the 3D object is rotated in response to receiving the input. In an exemplary embodiment, 3D object 120 is rotated around either the X-axis or the Y-axis responsive to receiving rotation instructions from a user. In an exemplary embodiment, rotation of 3D object 120 is implemented using the algorithms discussed above with respect to GUI 100. Accordingly, rotation about the X-axis may operate to change the user-specific information being displayed (e.g. treatment history, pump programming, etc.) by GUI 100, while rotation around the Y-axis operates to change the actual user interface being displayed (e.g. nurse, doctor, technician, etc.) by GUI 100.

It will be understood that method 200 is not limited to the above steps, but may include alternative steps and additional steps, as would be understood by one of ordinary skill in the art from the description herein.

For one example, it may be desirable that certain users of the infusion pump (e.g., a technician) are unable to access the surfaces associated with certain other users (e.g., a doctor or nurse). Accordingly, method 200 may further include the step of requiring a user to provide authorization information prior to rotating 3D object 120, similarly as described above with respect to GUI 100.

For another example, it may be desirable to present multiple 3D objects on the display screen. Accordingly, method 200 may further include the steps of receiving instructions to reposition the plurality of 3D objects 120, similarly as describe above with respect to GUI 100.

Aspects of the present invention achieve advantages not present in prior art GUIs, as set forth below.

The present invention provides a graphical user interface that facilitates the visual comprehension of information for devices having multiple different users. The embodiments described herein are particularly suitable for organizing and displaying user-specific information in a manner that is readily understood by the user. Additionally, the embodiments described herein demonstrate improved processes for transitioning between user-specific information in the GUI of a multiple user electronic device.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A graphical user interface for presenting information on a display screen of an electronic device comprising:
a three-dimensional (3D) object having a plurality of surfaces, the plurality of surfaces including one or more surfaces associated with a first user and one or more surfaces associated with a second user, the 3D object rotatable in order to selectively display at least one of the plurality of surfaces, wherein
rotation of the 3D object around a first axis changes the selectively displayed at least one surface between the one or more surfaces associated with the first user and the one or more surfaces associated with the second user, and
rotation of the 3D object around a second axis different from the first axis changes the selectively displayed at least one surface between one of the one or more surfaces associated with the first user and another one of the one or more surfaces associated with the first user.

2. The graphical user interface of claim 1, wherein the 3D object is a polyhedron.

3. The graphical user interface of claim 2, wherein the polyhedron is a cube.

4. The graphical user interface of claim 3, wherein the first and second axes are orthogonal.

5. The graphical user interface of claim 1, further comprising a plurality of 3D objects, each 3D object having a plurality of surfaces, the plurality of 3D objects repositionable in order to selectively display at least one of the plurality of surfaces of a single one of the plurality of 3D objects.

6. The graphical user interface of claim 5, wherein each of the plurality of 3D objects is associated with a separate operational mode of the electronic device.

7. A medical device for use in providing treatment to a patient, the medical device comprising:
a functional component configured to provide the treatment to the patient;
a display screen; and
a processor programmed to implement the graphical user interface of claim 1 on the display screen to present information related to the functional component.

8. The medical device of claim 7 wherein the processor is programmed to require a user to provide authorization information prior to enabling rotation of the 3D object around the first axis from the one or more surfaces associated with the second user to the one of more surfaces associated with the first user.

9. The medical device of claim 7,
wherein the graphical user interface further comprises a plurality of 3D objects, each 3D object having a plurality of surfaces, the plurality of 3D objects repositionable in order to selectively display at least one of the plurality of surfaces of a single one of the plurality of 3D objects, and
wherein each of the plurality of 3D objects is associated with a separate operational mode of the electronic device.

10. The medical device of claim 9 wherein the processor is programmed to require a user to provide authorization information prior to enabling repositioning of the plurality of 3D objects.

11. A method for presenting information on a display screen of an electronic device comprising the steps of:
presenting a three-dimensional (3D) object on the display screen, the 3D object having a plurality of surfaces, the plurality of surfaces including one or more surfaces associated with a first user and one or more surfaces associated with a second user;
receiving input from a user, the input comprising an instruction to rotate the 3D object in order to selectively display at least one of the plurality of surfaces; and
rotating the 3D object in response to receiving the input, wherein
rotation of the 3D object around a first axis changes the selectively displayed at least one surface between the one or more surfaces associated with the first user and the one or more surfaces associated with the second user, and
rotation of the 3D object around a second axis different from the first axis changes the selectively displayed at least one surface between one of the one or more surfaces associated with the first user and another one of the one or more surfaces associated with the first user.

12. The method of claim 11, wherein the presenting step comprising presenting a polyhedron in the display screen.

13. The method of claim 12, wherein the presenting step comprising presenting a cube in the display screen.

14. The method of claim 13, wherein the first and second axes are orthogonal.

15. The method of claim 11, further comprising the step of requiring a user to provide authorization information prior to rotating the 3D object around the first axis from the one or more surfaces associated with the second user to the one of more surfaces associated with the first user.

16. The method of claim 11, wherein the presenting step comprises presenting a plurality of 3D objects on the display screen, each 3D object having a plurality of surfaces.

17. The method of claim 16, further comprising the steps of:
receiving additional input from a user, the additional input comprising an instruction to reposition the plurality of 3D objects in order to selectively display at least one of the plurality of surfaces of a single one of the plurality of 3D objects; and
repositioning the plurality of 3D objects in response to receiving the additional input.

18. The method of claim 17, further comprising the step of requiring a user to provide authorization information prior to repositioning the plurality of 3D objects.
